(19) United States
(12) Patent Application Publication
(10) Pub. No.: US 2010/0091518 A1
(43) Pub. Date: Apr. 15, 2010

(54) Anti-Glare LED Planar Light Source Adapted For Reading Lamp

(76) Inventor: Chia-Ho Su, Taipei Hsien (TW)

Correspondence Address: LIN & ASSOCIATES INTELLECTUAL PROPERTY, INC., P.O. BOX 2339, SARATOGA, CA, 95070-0339, US

(21) Appl. No.: 12/251,435

(22) Filed: Oct. 14, 2008

(51) Int. Cl. F21V 8/00

(52) U.S. Cl. 362/606

(57) ABSTRACT

An anti-glare LED light source adapted for a reading lamp includes a housing having a good thermal conductivity, a light guide plate, at least one LED module, and an optical film stack. The light guide plate, the at least one LED module, and the optical film stack are disposed in the housing. The optical film stack is configured on a first surface of the light guide plate facing toward an opening of the housing. An optical structure adapted for fetching light thereby is configured at a second surface of the light guide plate. The second surface of the light guide plate faces toward an inside bottom of the housing. The inside bottom of the housing is further provided with a light reflective material. The LED module is disposed at a lateral side of the light guide plate, for projecting light into the light guide plate.

### BACKGROUND OF THE INVENTION

1. Field of the Invention

The present invention relates generally to an anti-glare LED light source adapted for a reading lamp.

2. The Prior Arts

Having the outstanding advantages of power saving and longer lifespan, LEDs have become a dominant tendency of light sources to be developed in the future. However, an LED is a spot light having a highly concentrated brightness. An excessively high luminance of such a spot light may cause a direct glare which makes the user feel uncomfortable. Specifically, when such a spot light is used as a light source of a reading lamp, it may annoy the user's reading.

Further, both of those conventional light sources and other conventional LED modules often have the problems of indirect glares. The indirect glares are often caused by too large light emitting angle of the reading lamp. After being reflected by the illuminated objects, the reflected light of the emitted light often causes the reader feeling uncomfortable.

### SUMMARY OF THE INVENTION

A primary objective of the present invention is to provide a solution of the problem that when an LED is used as a light source for a reading lamp, the brightness of the light source is much concentrated thus generating a glare.

The present invention is featured in that it employs a light guiding technology to guide a spot light beam emitted from an LED light source into a light guide plate, thus forming a planar light source. In such a way, the spot light source can be converted into a surface light source, which is softer, more uniform, and emits light from the entire surface thereof. Further, the present invention combines an optical film with the light guide plate, so as to utilize the optical characteristic of the optical film to effectively reduce the light emitting angle. In such a way, a large angle light beam which causes the indirect glare can be transferred to a positive direction, thus avoiding occurrence of the glare, and improving the illumination efficiency of the reading lamp.

Accordingly, the present invention provides an anti-glare LED light source adapted for a reading lamp. The anti-glare LED light source includes a housing having a good thermal conductivity, a light guide plate, at least one LED module, and an optical film stack. The light guide plate, the at least one LED module, and the optical film stack are disposed in the housing. The optical film stack is configured on a first surface of the light guide plate facing toward an opening of the housing. An optical structure adapted for fetching light thereby is configured at a second surface of the light guide plate. The second surface of the light guide plate faces an inside bottom of the housing. The inside surface of the housing is further provided with a light reflective material. The LED module is disposed at a lateral side of the light guide plate in the housing, for projecting light into the light guide plate. The light is then transmitted in the light guide plate. The optical structure adapted for fetching light thereby is adapted for destroying a total reflection of the light inside the light guide plate, so as to retrieve the light out from the light guide plate. The light reflective material facilitates to improve the efficiency, and the optical film stack helps to form a uniform, soft, and anti-glare reading lamp.

According to an embodiment of the present invention, the housing can be integrally configured with a heat dissipation structure, for increasing a heat dissipation area thereof, so as to improve the heat dissipation efficiency thereof.

According to an embodiment of the present invention, the optical film stack includes a diffusion film and a brightness enhancement film, so that when passing through the optical film stack, a light can be uniformed and softened, and the spot light source can be converted into a planar light source.

The optical structure adapted for fetching light thereby disposed at the light guide plate, can be a plurality of micro-protrusions or a plurality of micro-recesses integrally configured at the second surface of the light guide plate, or a plurality of dot shaped patterns configured by ink printing or injection molding on the second surface of the light guide plate. The micro-protrusions or the micro-recesses, or the dot shaped patterns are adapted for refracting the light before the light being outputted from the light guide plate, so as to improve a brightness of the light source.

According to another embodiment of the present invention, the anti-glare light source further includes an optical reflective material disposed on an inside surface of the housing facing toward the second surface of the light guide plate. The optical reflective material is adapted for reflecting the light guided into the light guide plate, and after being reflected by the optical reflective material, the light is then refracted by the optical structure adapted for fetching light thereby. In such a way, the brightness of the light source is further improved.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view illustrating a planar light source used as a reading lamp according to an embodiment of the present invention;

FIG. 2 is an exploded perspective view illustrating the structural relationship of the elements of the planar light source according to an embodiment of the present invention;

FIG. 3 is a cross-sectional view of the planar light source according to an embodiment of the present invention;

FIG. 4 is a partial enlarged view of a plurality of micro-protrusions of the optical structure of the light guide plate according to an embodiment of the present invention; and

FIG. 5 is a partial enlarged view of a plurality of micro-recesses of the optical structure of the light guide plate according to an embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

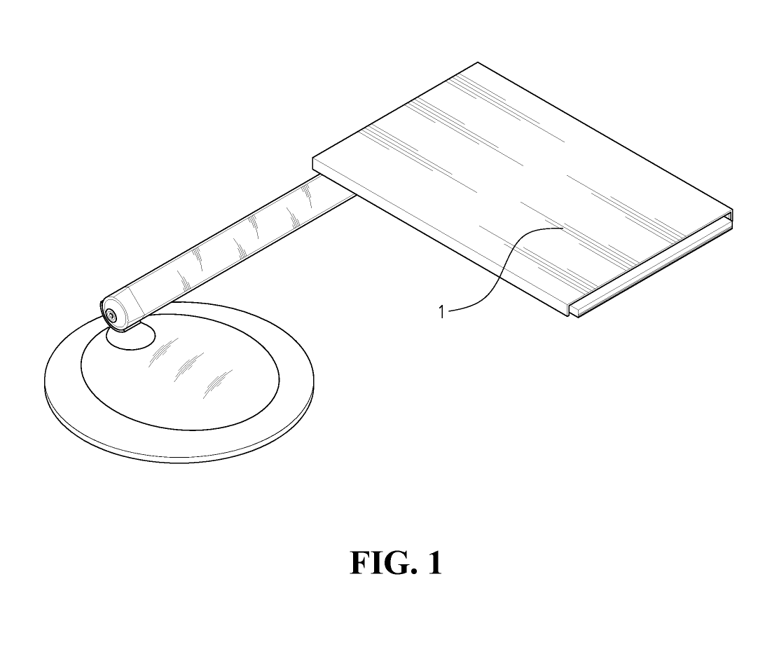

FIG. 1 is a schematic view illustrating an LED planar light source used as a reading lamp according to an embodiment of the present invention.

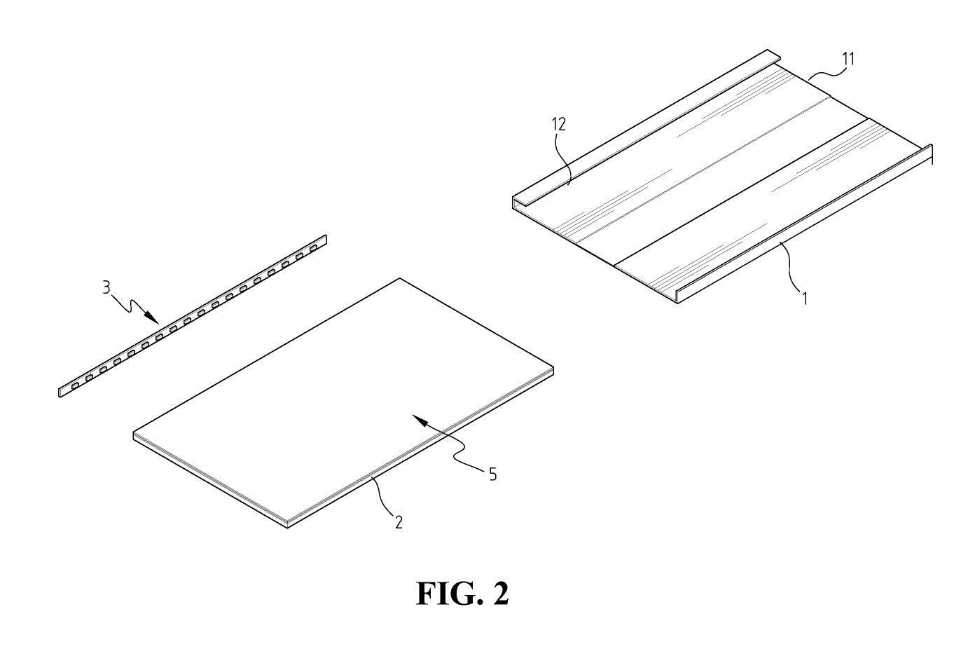

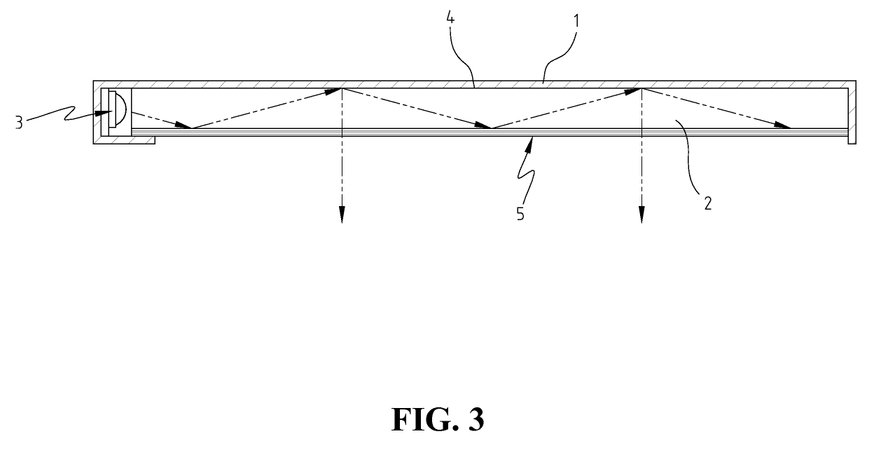

FIG. 2 is an exploded perspective view illustrating the structural relationship of the elements of the planar light source according to an embodiment of the present invention, and FIG. 3 is a cross-sectional view of the planar light source according to an embodiment of the present invention. Referring to FIGS. 1-3, according to a preferred embodiment of the present invention, the LED planar light source includes a housing 1, a light guide plate 2, an LED module 3, and at least one optical film stack 5. The housing 1 is made of a material having a good thermal conductivity, such as aluminum or the like. The housing 1 is configured with an opening 11. The housing 1 is preferred but not restricted to be integrally configured with a heat dissipation structure at an outside surface of the housing 1. For example, the heat dissipation structure can be a plurality of plates extending out from the outside surface of the housing 1 for enlarging a heat dissipation area thereof.

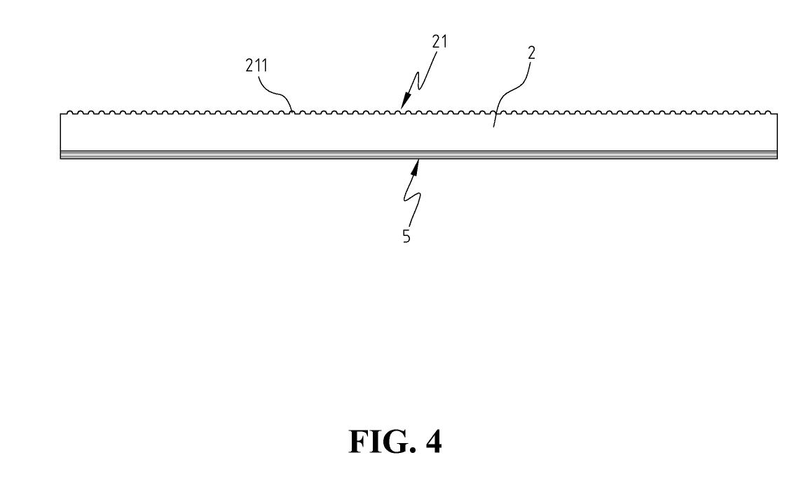

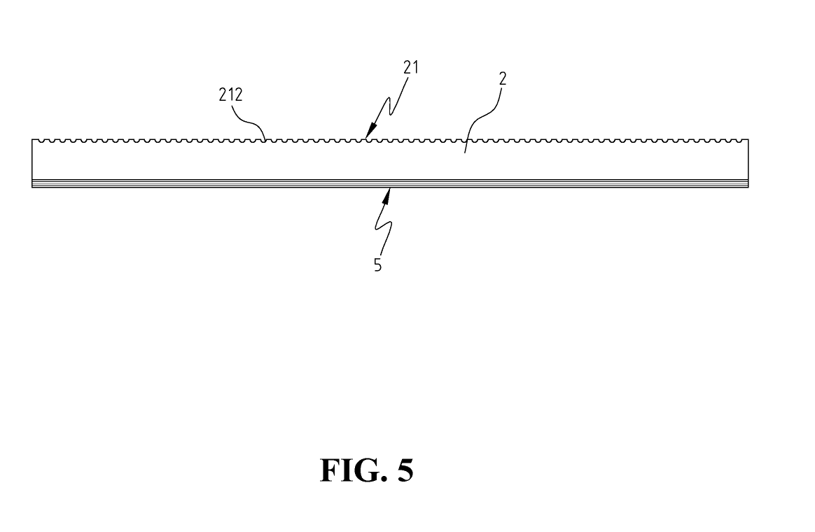

The light guide plate 2 is a flat plate made of an optical material having a good light conductivity. The light guide plate 2 is accommodated inside the housing 1. The light guide plate 2 is configured with a first surface and a second surface. The first surface is opposite to the second surface. The second surface is configured with an optical structure 21 adapted for fetching light thereby. The first surface is disposed facing toward the opening 11 of the housing 1. The optical structure 21 adapted for fetching light thereby can be a plurality of micro-protrusions 211 (as shown in FIG. 4) or a plurality of micro-recesses 212 (as shown in FIG. 5) integrally configured at the second surface of the light guide plate 2, or a plurality of dot shaped patterns (not shown in the drawings) configured by ink printing or injection molding on the second surface of the light guide plate 2. Before the light guide plate 2 is assembled into the housing 1, a reflective material 4 can be provided at an inside bottom of the housing 1, so that after the light guide plate 2 is assembled into the housing 1, the second surface of the light guide plate 2 faces toward the reflective material 4.

The LED module 3 is disposed at a lateral side of the light guide plate in the housing 1, or even also at another lateral side opposite thereto. The LED module 3 includes a circuit board, at least one LED electrically connected to the circuit board, a wire electrically connected to a power supply. When a current is provided, the LED emits light, and projects the light into the light guide plate 2.

The optical film stack 5 is provided on the first surface of the light guide plate 2 facing toward the opening 11 of the housing 1. The optical film stack 5 includes at least one diffusion film or at least one brightness enhancement film.

When assembling, the optical film stack 5 and the LED module 3 are assembled to the light guide plate 2, and then the three parties as a whole is assembled into the housing 1.

In operation, the LED module 3 generates and projects the light in the light guide plate 2. The light is then guided for transmitting inside the light guide plate 2. Meanwhile, the light is reflected by the reflective material 4 and refracted by the micro-protrusions 211, micro-recesses 212, or ink dot shaped patterns, to achieve an improved brightness. After being reflected and refracted thereby, the light is then outputted through light guide plate 2 and the optical film stack 5, thus configuring a uniform, soft, and anti-glare reading lamp.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An anti-glare LED planar light source adapted for a reading lamp, comprising:
a housing, made of a thermal conductive material, the housing being configured with an opening;
a light guide plate, accommodated inside the housing, the light guide plate being configured with a first surface and a second surface opposite to each other, wherein the first surface is configured facing toward an opening of the housing, and the second surface is configured with an optical structure adapted for fetching light thereby;
an LED module, disposed at at least one lateral side of the light guide plate in the housing, for projecting light into the light guide plate; and
an optical film stack, disposed on the first surface of the light guide plate.

2. The anti-glare LED planar light source according to claim 1, wherein the optical structure adapted for fetching light comprises a plurality of micro-protrusions integrally configured at the second surface of the light guide plate.

3. The anti-glare LED planar light source according to claim 1, wherein the optical structure adapted for fetching light comprises a plurality of micro-recesses integrally configured at the second surface of the light guide plate.

4. The anti-glare LED planar light source according to claim 1, wherein the optical structure adapted for fetching light comprises a plurality of dot shaped patterns provided on the second surface of the light guide plate.

5. The anti-glare LED planar light source according to claim 1, wherein the optical film stack comprises at least one diffusion film and at least one brightness enhancement film.

6. The anti-glare LED planar light source according to claim 1, wherein the housing is further provided with an optical reflective material on an inside surface of the housing facing toward the second surface.

7. The anti-glare LED planar light source according to claim 1, wherein the housing is integrally configured with a heat dissipation structure at an outside of the housing.
